(19) United States
(12) Patent Application Publication
(10) Pub. No.: US 2026/0054784 A1
(43) Pub. Date: Feb. 26, 2026

(54) ROTATING BUSHING CHAIN

(71) Applicant: Deere & Company, Moline, IL (US)

(72) Inventors: Patrick J. Mulligan, Dubuque, IA (US); Michael R. Heiar, Dubuque, IA (US); Trent A. Luoma, Dubuque, IA (US); Michael R Tigges, Dubuque, IA (US)

(21) Appl. No.: 18/812,161

(22) Filed: Aug. 22, 2024

(51) Int. Cl. B62D 55/21

(52) U.S. Cl. CPC B62D 55/21

(57) ABSTRACT

An endless track chain includes a first and a second link set. Each link set includes two links. The links have aligned bores. A cartridge is received through the bores and connects the link sets to permit relative rotation therebetween. The cartridge includes a pin, a bushing journaled on the pin, first and second collars rotatably disposed on the pin on axially opposite sides of the bushing, and third and fourth collars disposed on the pin axially outboard of the first and second collars. The first and second collars are received in the bores of the first and second links and have axially form-fitting connections to the first and second links. The pin and the third and fourth collars are fixed relative to the third and fourth links.

### BACKGROUND OF THE DISCLOSURE

### 1. Field of Disclosure

The present disclosure relates to an endless track chain for a track-type vehicle, and, more particularly, to a track chain cartridge that acts as a joint for relative rotation between links of the track chain.

### 2. Description of the Prior Art

Track-type vehicles (e.g., crawlers, excavators, tracked tree-felling machines) have an undercarriage typically with at least one track on each side of the vehicle. Each track typically includes an endless track chain, with ground-engaging shoes mounted thereon, trained about a drive sprocket, one or more idlers, and rollers. In many cases, each track chain includes a number of joints, each such joint interconnecting a first link set, having a first link and a second link, and a second link set, having a third link and a fourth link, for relative rotation between the first and second link sets as the track chain advances through its closed-loop path.

Such track chains have been constructed using cartridge type rotating bushings, such as for example those shown in U.S. Pat. No. 10,046,816. Using such cartridges axially inner chain links are pressed onto the free-wheeling axially inner collars of the cartridges. Such assemblies are more susceptible to twisting than were traditional track chain constructions, and eventually can result in loss of integrity due to link walking. To minimize that problem prior track chain designs have sometimes resorted to knurling the outer diameters of the axially inner collars of the cartridge to maximize the press fit values between the axially inner collars and the axially inner chain links to which they are attached. Such track chain constructions continue to be subject to link walking where an axially inner link walks towards an axially outer link due to failure of the press fit connection between the axially inner collar and the axially inner link. When an inner link contacts an outer link, heat is generated which is harmful to the polyurethane seals used in the cartridges, thereby compromising the useful life of the track chain.

There is a need for improved designs for track chains to eliminate the problems noted above.

### SUMMARY OF THE DISCLOSURE

The present disclosure eliminates the need for knurling and the corresponding very high press fits between the axially inner collars and the axially inner links of a cartridge joint for a track chain, and instead introduces a blind internal square section snap ring which axially locks each axially inner collar with its associated axially inner link to add to the strength of the press fit connection. This adds several tons of axial rigidity to the joint. This also facilitates chain assembly because less force is needed to assemble the chain. Local strains on chain components are decreased.

In one embodiment an endless track chain for use with a track-type vehicle includes a first link set and a second link set, the first link set including a first link and a second link, the second link set including a third link and a fourth link. The first, second, third and fourth links include first, second, third and fourth bores therethrough. A cartridge is received through the first, second, third and fourth bores and connects the first link set and the second link set to permit relative rotation between the first link set and the second link set. The cartridge includes a pin and a bushing journaled on an axially central portion of the pin for relative rotation between the bushing and the pin. First and second collars are rotatably disposed on the pin on axially opposite sides of the bushing, the first and second collars being received in the first and second bores and having and axially form-fitting connections to the first and second links. Third and fourth collars are disposed on the pin axially outboard of the first and second collars, respectively, the third and fourth collars being rotationally fixed within the third and fourth bores and rotationally fixed to the pin, so that the pin and the third and fourth collars are fixed relative to the third and fourth links.

In another embodiment a method is provided of assembling one end portion of a rotating pin cartridge assembly with an axially inner chain link. The cartridge assembly includes a pin, an axially inner collar rotatably received on the pin, and an axially outer collar rotationally fixed to the pin. The method includes: radially compressing a resilient locking ring within a radially outwardly facing groove of the axially inner collar; passing the axially outer collar through a bore of the axially inner chain link; axially moving the axially inner collar into the bore of the axially inner chain link while holding the resilient locking ring radially compressed within the groove until the groove of the axially inner collar aligns with a radially inward facing groove of the bore of the axially inner chain link; and expanding the resilient locking ring into the radially inward facing groove of the bore of the axially inner chain link to axially lock the axially inner collar to the axially inner chain link.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a side elevation view of a simplified track-type vehicle (e.g., crawler dozer) having an undercarriage shown diagrammatically.

FIG. 2 is an enlarged side elevation view showing an endless track chain trained about a drive sprocket.

FIG. 3 is a plan view showing the track chain trained about a drive sprocket.

FIG. 4 is a sectional view taken along lines 4-4 of FIG. 3 showing a cartridge joined to a number of links of the track chain.

FIG. 5A is a first schematic perspective view of a pre-assembled cartridge and two installation clamping tools used to assemble the cartridge with the links of the endless track chain.

FIG. 5B is second schematic perspective view of the pre-assembled cartridge and two installation clamping tools used to assemble the cartridge with the links of the endless track chain, taken from the opposite end of the cartridge as compared to FIG. 5A.

FIG. 6 is a schematic cross-sectioned view of the cartridge of FIG. 5A, partially assembled with a first link. An axially outboard collar of the cartridge is passing through the bore of the first link.

FIG. 7A is a schematic cross-sectioned view similar to FIG. 6, and sequential to FIG. 6, showing an axially inboard collar of the cartridge beginning to move into the bore of the first link.

FIG. 7B is an enlarged view of the area of FIG. 7A surrounding the resilient locking ring.

FIG. 8A is a schematic cross-sectioned view similar to FIG. 7A, and sequential to FIG. 7A, showing the cartridge assembled with the first link. The resilient locking ring of the axially inner collar now axially locks the axially inner collar to the first link.

FIG. 8B is an enlarged view of the area of FIG. 8A surrounding the resilient locking ring.

### DETAILED DESCRIPTION

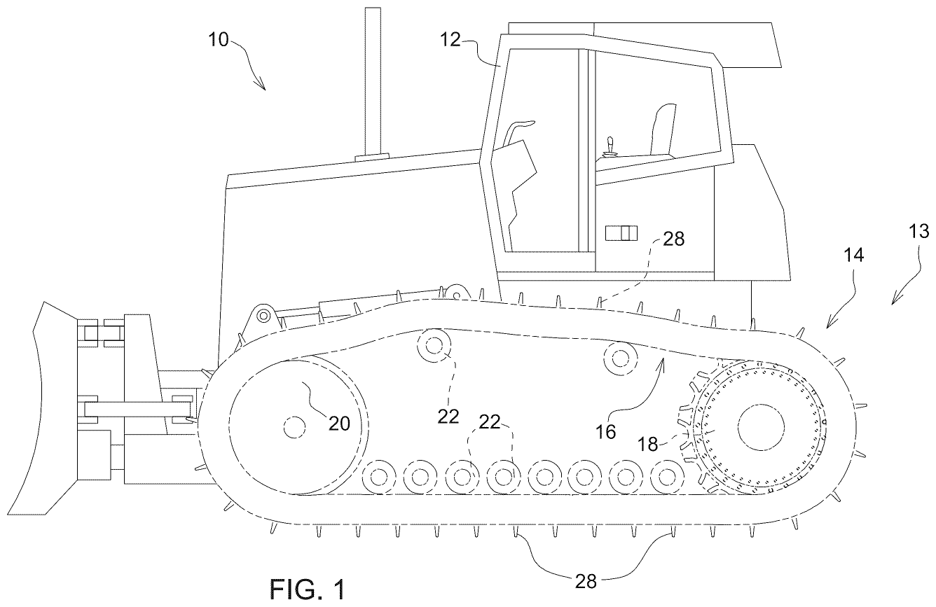

Referring to FIG. 1, there is shown a simplified track-type vehicle 10, illustratively a crawler dozer, although it could be any track-type vehicle. The vehicle 10 includes an operator's station 12 from which a human operator can control functions of the vehicle 10 including propulsion and steering. The undercarriage 13 of the vehicle 10 has a track 14 on each side of the vehicle 10 for propulsion and steering of the vehicle 10. In the illustrated example, each track 14 is trained about a rear drive sprocket 18, a front idler 20, and a number of rollers 22. A track frame of the undercarriage 13 (track frame not shown) is attached to the base machine and is located between the drive sprocket 18 and the idler 20 within the track 14, and the idler 20 and the rollers 22 are attached to the track frame.

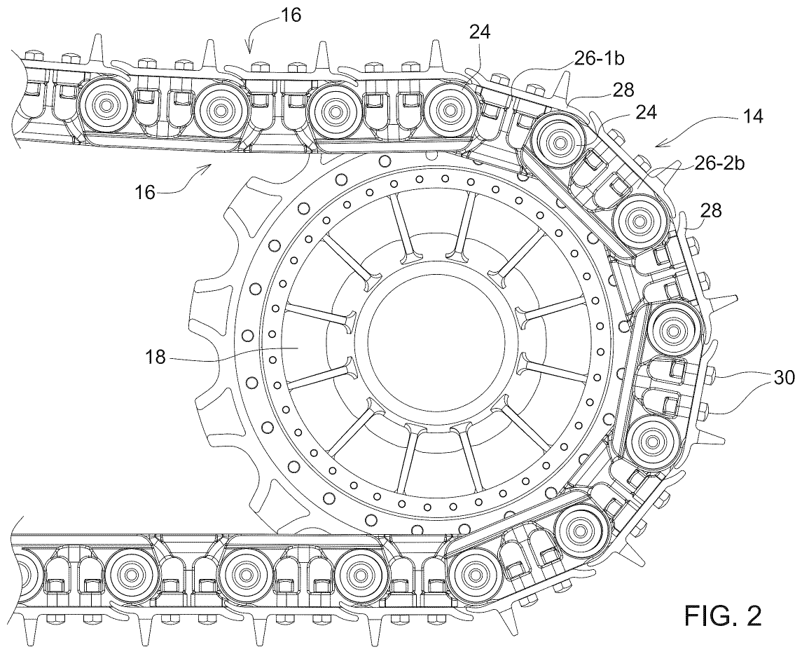

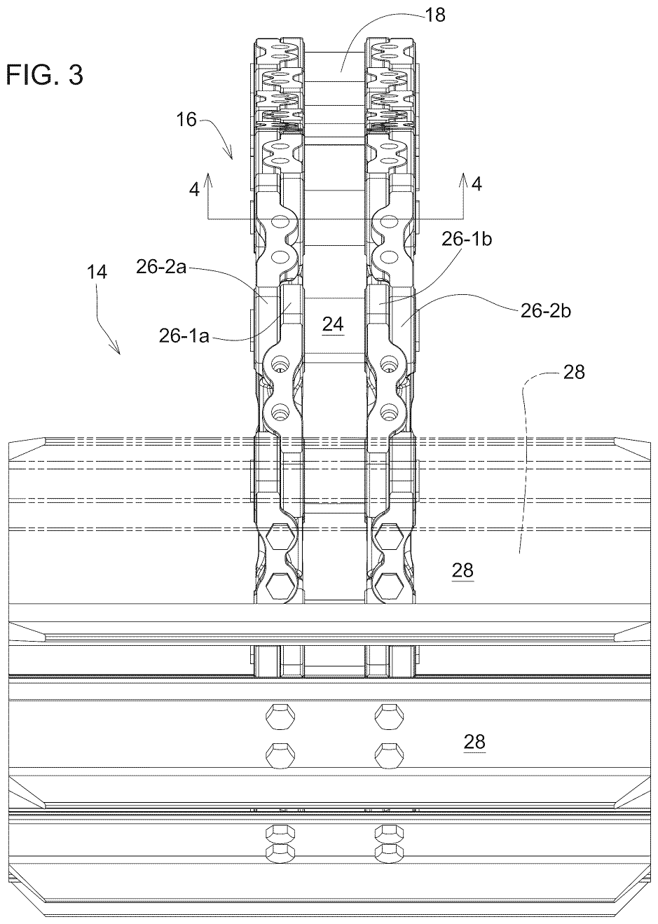

Referring to FIGS. 2 and 3, each track 14 includes an endless track chain 16 and ground-engaging shoes 28 attached to the chain 16. The chain 16 includes a number of joints each configured as a cartridge 24, links 26 interconnected by the cartridges 24, and four master links (not shown), two which are attached to a first cartridge 24 and two of which are attached to a second cartridge 24 such that the master links attached to the first cartridge 24 are respectively attached to the master links attached to the second cartridge 24. Shoes 28 are attached to the links 26 via bolts 30 (a shoe 28 would also be bolted to the master links). Each cartridge 24 acts as a pivot for links 26 attached to that cartridge 24 and adjacent cartridges 24 on opposite sides thereof. Further, as a wear component, it engages the sprocket 18 between the teeth thereof and the idler 20 during advancement of the track 14. As discussed in more detail below, each cartridge 24 is assembled as a cartridge before introduction to any of the links 26, enhancing the leakage resistance and manufacturing repeatability of the joint. Chain 16 shown in FIGS. 2 and 3 is of the parallel link type including two inner links 26-1a and 26-1b and two outer links 26-2a and 26-2b forming each link joint with one of the cartridges 24 as is further described below.

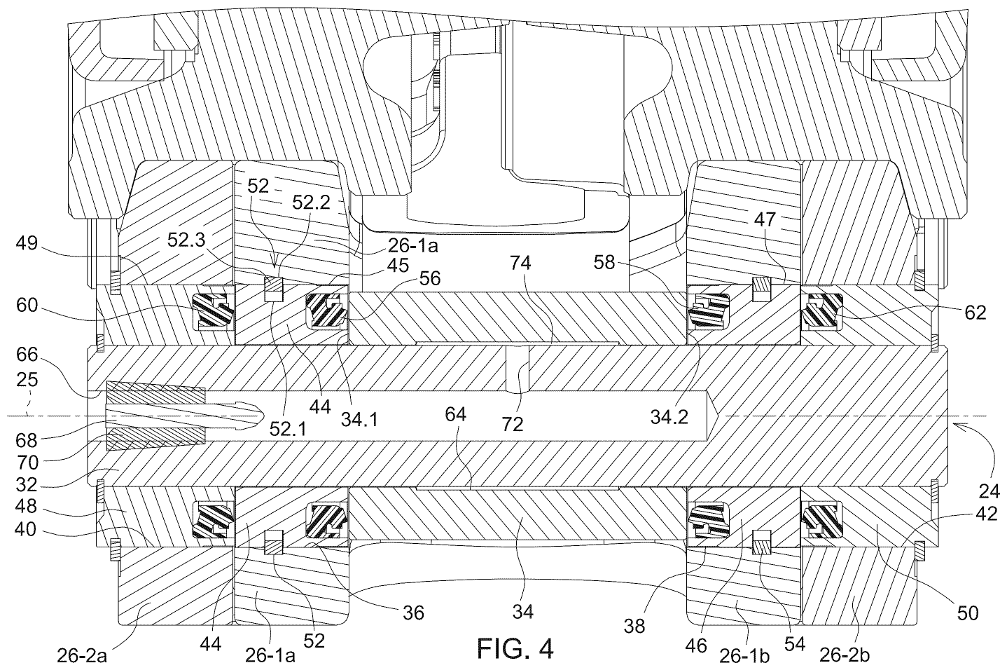

Referring to FIG. 4, as it relates to a cartridge 24 and the links 26 attached thereto, terms herein such as “radial” and “axial,” and their variants, are relative to a central longitudinal axis 25 of the cartridge 24. A first link 26-1a and a second link 26-1b cooperate to provide a first link set, and a third link 26-2a and a fourth link 26-2b cooperate to provide a second link set. Each cartridge 24 is joined to and distinct from the first link 26-1a, the second link 26-1b, the third link 26-2a, and the fourth link 26-2b for relative rotation between the first link set with its links 26-1a, 26-1b and the second link set with its links 26-2a, 26-2b. The third link 26-2a is positioned axially outboard of the first link 26-1a, and the fourth link 26-2b is positioned axially outboard of the second link 26-2a.

The first, second, third and fourth links include first, second, third and fourth bores 36, 38, 40 and 42, respectively, therethrough. The cartridge 24 is received through the first, second, third and fourth bores 36, 38, 40 and 42 and connects the first link set with its links 26-1a, 26-1b and the second link set with its links 26-2a, 26-2b to permit relative rotation between the first link set and the second link set.

The cartridge 24 includes a pin 32 and a bushing 34 journalled on an axially central portion of the pin 32 so as to be radially outward of and surround the pin 32 for relative rotation between the bushing 34 and the pin 32.

The cartridge 24 further includes first and second collars 44 and 46 rotatably disposed on the pin 32 on axially opposite sides of the bushing 34. The first and second collars 44 and 46 are received in the first and second bores 36 and 38, respectively, and have axially form-fitting connections 52 and 54 to the first and second links 26-1a and 26-1b, respectively. A form-fitting connection is a mechanical connection between two parts that interlock and block each other along a defined direction. Additionally, the first and second collars 44 and 46 may be press fit within the first and second bores 36 and 38 to provide further connection between the first and second collars 44 and 46 and the first and second links 26-1a and 26-1b, respectively.

The cartridge 24 further includes third and fourth collars 48 and 50 disposed on the pin 32 axially outboard of the first and second collars 44 and 46, respectively, the third and fourth collars 48 and 50 being rotationally fixed within the third and fourth bores 40 and 42 and rotationally fixed to the pin 32, so that the pin 32 and the third and fourth collars 48 and 50 are fixed relative to the third and fourth links 26-2a and 26-2b. The third and fourth collars 48 and 50 may be press fit to the pin 32 to provide the rotationally fixed connection to the pin 32. Upon assembly with the third and fourth links 26-2a and 26-2b the third and fourth collars 48 and 50 may be press fit within the third and fourth bores 40 and 42 to provide the rotationally fixed connection between the third and fourth collars 48 and 50 and the third and fourth links 26-2a and 26-2b, respectively.

It is noted that the third collar 48 may have a radially outer surface 49 with an outside diameter less than an inside diameter of the first bore 36 of the first link 26-1a so that the third collar 48 may pass axially through the first bore 36 during assembly, as is further described below, without being press fit through the first bore 36.

Each of the form fitting connections 52 and 54 may be embodied as a pair of grooves and a resilient lock ring or snap ring received in the grooves. For example, form fitting connection 52 may include a radially outward facing groove 52.1 defined in an outer surface 45 of the first collar 44, a radially inward facing groove 52.2 defined in an inner surface of the first bore 36 of the first link 26-1a, and a resilient locking ring 52.3 partially received in each of the grooves 52.1 and 52.2 to axially lock the first collar 44 to the first link 26-1a. As can be seen in FIG. 4, the resilient locking ring 52.3 may have a rectangular or a square cross-section. Other shape cross-sections could be used, such as trapezoidal or half-round shapes.

This interlocking groove and ring structure provides an axially form fitting connection 52 between the first collar 44 and the first link 26-1a which greatly increases the axial loads which can be carried by the track chain 16 without distortion of the links of the chain. The first collar 44 may also be press fit within the bore 36 of the first link 26-1a. A typical press fit between the first collar 44 and the first link 26-1a may require an axial load in the range of from about 15 ton to about 20 ton to displace the press fit. The interlocking groove and ring structure of the axially form fitting connection 52 may add an additional axial load carrying capability in the range of 10 ton to 12 ton for a 3 mm wide ring 52.3. With this form fitting connection 52, there is no need to knurl or otherwise treat the outer surface 45 of the first collar 44 as was done in the prior art to increase the axial loads which could be carried by relatively high press fit connection between the collar and the link as was done in the prior art.

The second form fitting connection 54 may be identically constructed and may include a radially outward facing groove 54.1 defined in an outer surface 47 of the second collar 46, a radially inward facing groove 54.2 defined in an inner surface of the second bore 38 of the second link 26-1b, and a resilient locking ring 54.3 partially received in each of the grooves 54.1 and 54.2 to axially lock the second collar 46 to the second link 26-1b.

The first and second collars 44 and 46 may include first and second seal rings 56 and 58, respectively, engaging opposite axial ends 34.1 and 34.2 of the bushing 34. The third and fourth collars 48 and 50 may include third and fourth seal rings 60 and 62, respectively, engaging axially outer ends of the first and second collars 44 and 46, respectively. Each seal ring includes a seal loading element, made of, for example, nitrile, and a seal body loaded by the seal loading element to contact the respective component to establish a sealed connection therebetween and made of, for example, polyurethane.

The pin 32 is formed to include a blind axial channel 64. The axial channel 64 is closed at one end by the pin 32 itself and has an opening 66 at the other end. The opening 66 is ordinarily closed by a plug 68 made of, for example, plastic (e.g., polyurethane) and received by a grommet 70 made of, for example, a soft rubber and mounted in the channel 64 to prevent leakage of lubricant through the opening 66 from the axial channel 64. The lubricant is a conventional lubricant, such as, for example, an 80 W90-type of oil, which may have additives.

The pin 32 has a radial channel 72 to communicate lubricant between the axial channel 64 and an interface 74 between the bushing 34 and the pin 32 for lubrication of the interface 74 and relative rotation between the bushing 34 and the pin 32.

The pre-assembled cartridge nature of the cartridge 24 enhances manufacturability, leakage resistance, and serviceability of the chain 16. More particularly, the cartridge nature of the cartridge 24 promotes joint assembly repeatability and simplification of attachment to the links 26-1a, 26-1b, 26-2a, 26-2b. Leakage resistance is due to the tight tolerances that can be attained by pre-assembly. Further, it promotes serviceability in that the cartridge 24 can be readily replaced in the shop or in the field with minimal operational down-time.

### Methos of Assembly

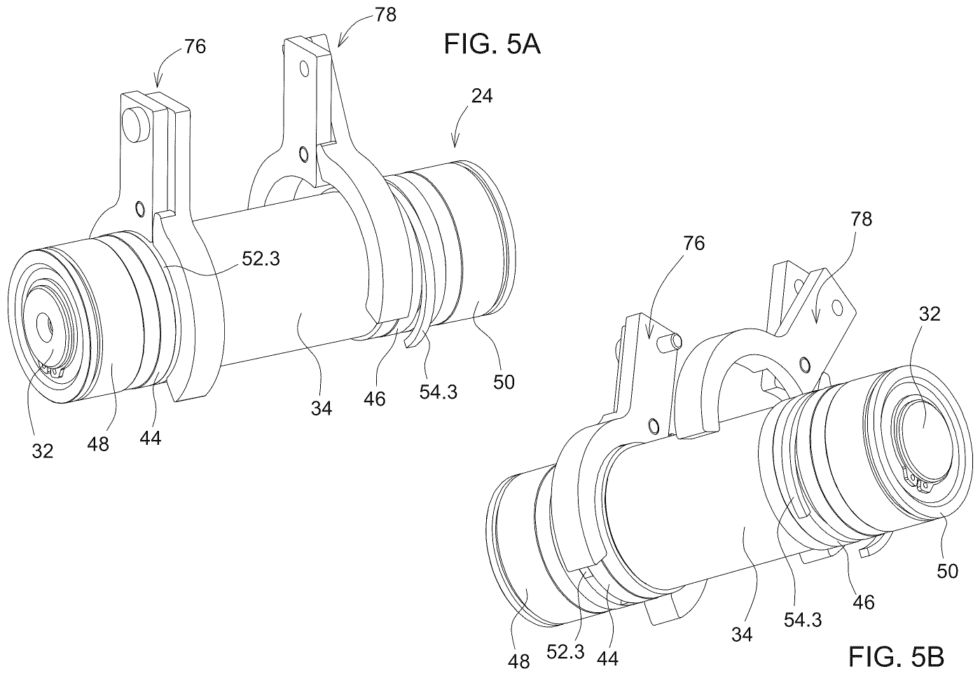

During assembly of the chain 16, the links 26-1a, 26-1b, 26-2a, 26-2b are joined to the pre-assembled cartridge 24 using a hydraulic press. Certain steps of one assembly method are schematically illustrated in FIGS. 5A-8B. FIGS. 5A-8B schematically illustrate the assembly of the cartridge 24 with the first link 26-1a.

FIGS. 5A and 5B are two perspective views showing the engagement of a cartridge 24 with two installation clamping tools 76 and 78. The clamping tool 76 is shown in a clamped position radially compressing the resilient locking ring 52.3 in a radially contracted position within the outward facing groove 52.1 of the first collar 44, prior to assembly of the cartridge 24 with the first link 26-1a. The clamping tool 78 is shown in an unclamped position and the resilient locking ring 54.3 is shown in a radially expanded position wherein it is partially received in the outward facing groove 54.1 of the second collar 46.

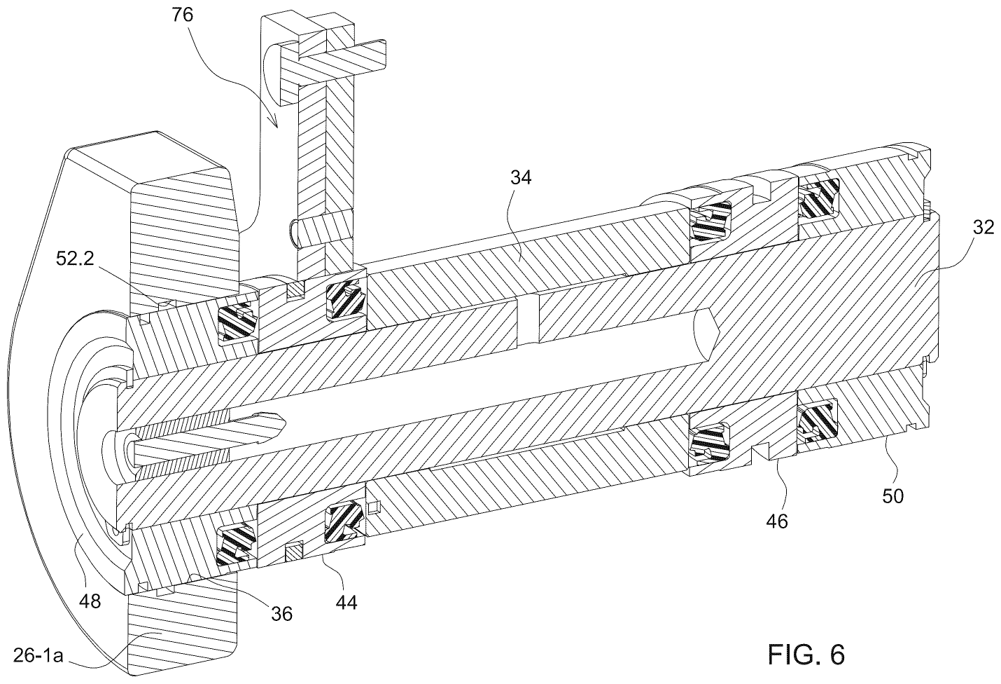

FIGS. 6, 7A and 8A are a sequential series of views showing the third collar 48 passing through the bore 36 of the first link 26-1a. This may also be described as passing the axially outer collar 48 through the bore 36 of the axially inner chain link 26-1a, with reference to the final positions of the components in the assembled chain. In one embodiment there is no press fit between the third collar 48 and the bore 36 of the first link 26-1a as the third collar 48 passes through the bore 36.

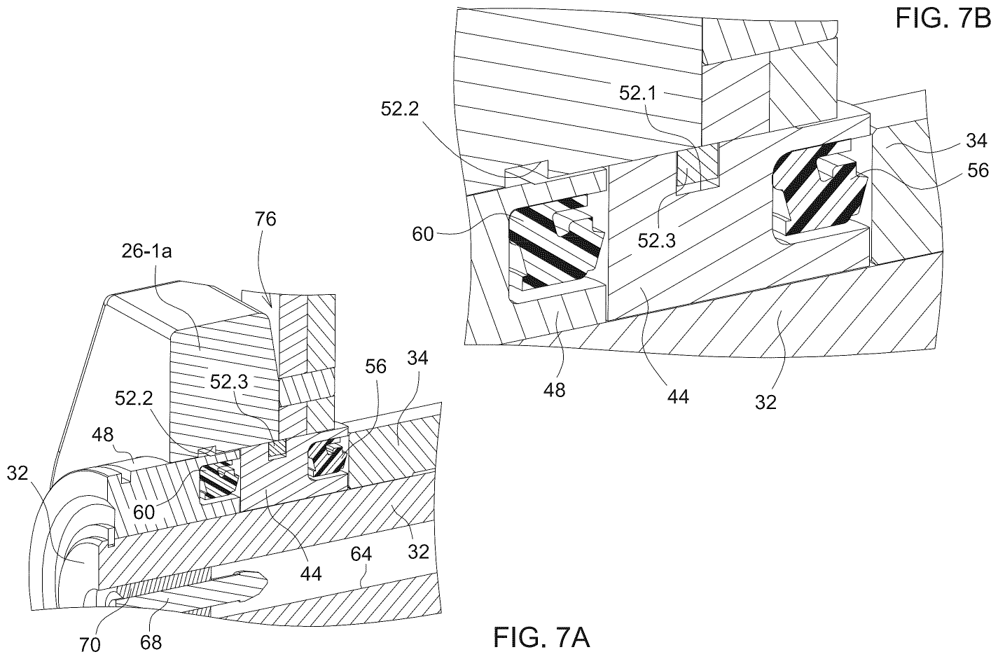

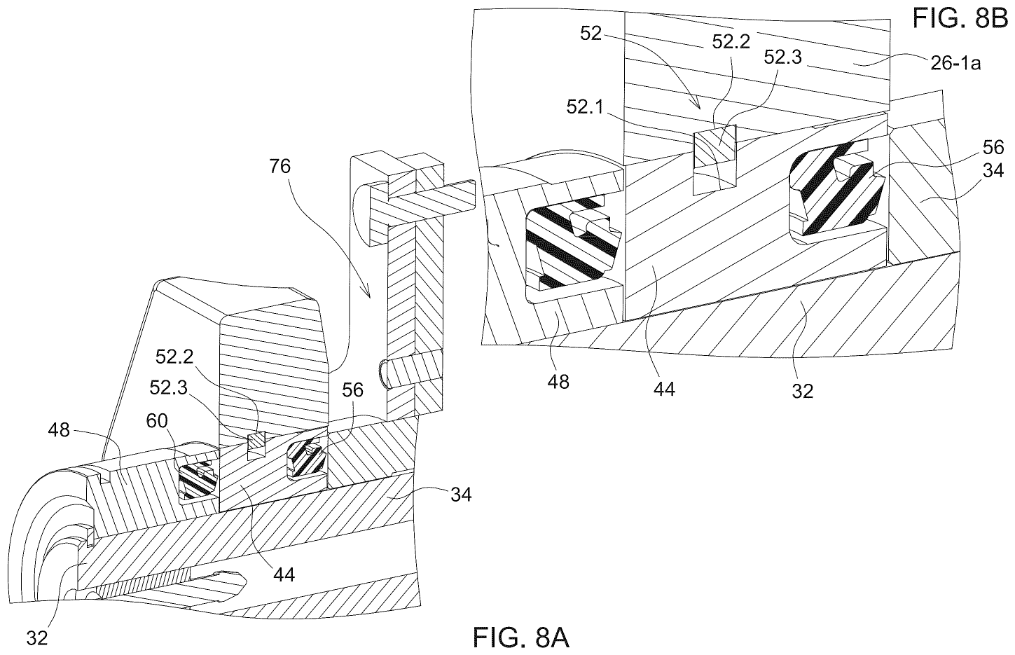

In FIG. 6 the first bore 36 of first link 26-1a is placed axially over the end of third collar 48. As seen in FIG. 7A, the first link 26-1a continues to be pressed onto the cartridge 24 and the first collar 44 has begun to move axially into the bore 36 of the first link 26-1a, while the installation clamping tool 76 is holding the resilient locking ring 52.3 radially compressed within the groove 52.1 until the resilient locking ring 52.3 begins to slide into the first bore 36 as seen in FIGS. 7A and 7B. The installation clamping tool 76 slides off of the first collar 44 and the first link 26-1a continues to be pressed onto the first collar 44 until the radially inwardly facing groove 52.2 aligns with the radially outward facing groove 52.1 as shown in FIG. 8A. When the grooves align, the resilient locking ring 52.3 expands partially into the radially inward facing groove 52.2 thereby axially locking the first collar 44 to the first link 26-1a.

Then the second link 26-1b may be assembled with the second collar 46 in a similar manner using the second installation clamping tool 78 and pressing the second link 26-1b onto the opposite end of the cartridge 24. Then the third and fourth links 26-2a and 26-2b may be press fit onto the third and fourth collars 48 and 50, respectively.

It will be understood that the endless track chain 16 is assembled onto two of the cartridges 24 simultaneously. If the links 26-1a, 26-1b, 26-2a and 26-2b are parallel links as shown in FIG. 3, then the two inner links 26-1a and 26-1b will be assembled with two cartridges 24 simultaneously. Another pair of inner links 26-1a and 26-1b will be assembled with two more cartridges 24. Then a pair of outer links 26-2a and 26-26 may be pressed onto the outer collars of the two cartridges. The process is repeated until the desired chain link is present and the final connections are made using master links.

Alternatively, the links 26-1a, 26-1b, 26-2a and 26-2b could be offset links where one end of each link forms an axially outward link for assembly with one cartridge 24 and the other end of each link forms an axially inboard link for assembly with another cartridge 24.

In use, the cartridge 24 acts as a joint for the links 26-1a, 26-1b, 26-2a, 26-2b, allowing relative rotation between the first and second links 26-1a, 26-1b and the third and fourth links 26-2a, 26-2b. The bushing 34 is freely rotatable about pin 32. The bushing 34 engages and is driven by the sprocket 18. Torsional rigidity of the chain 16 is maximized due to axial fixation of the first and second links 26-1a, 26-1b to first and second collars 44 and 46 by the form fitting connections 52 and 54..

Other measures could be taken to further retain the pin 32 in place within the cartridge 24. For example, retaining rings could be used between the pin 32 and the third and fourth collars 48 and 50 as shown in FIG. 6. In such a case, an annular groove may be formed in the pin 32 therearound at each end of the pin 32. A retaining ring may be fitted into each such groove so as to contact a respective collar 48, 50, further retaining the pin 32 in place. In another example, the collars 48, 50 may be welded (e.g., laser-welded) to the pin 32. Such retention mechanisms may be employed individually or collectively, along with the press-fits between the collars 48, 50 and the pin 32.

Regarding materials, the pin 32, bushing 34, collars 44, 46, 48, 50, and links 26-1a, 26-1b, 26-2a, 26-2b may be made of, for example, an alloy steel conventional in the undercarriage industry. Boron, chromium molybdenum, and manganese may be included with the base material of such component.

The metal components of the cartridge 24 (i.e., pin 32, bushing 34, and collars 44, 46, 48, 50) and the links 26-1a, 26-1b, 26-2a, 26-2b may be made of a conventional material. The pin 32 and collars 44, 46, 48, 50 may be made of the base material used for pins on conventional sealed-and-lubricated chains (SALT chains) (i.e., chains with a pin, a bushing journalled on the pin, two links press-fitted to the bushing, and two links press-fitted to the pin). For example, such components may be made of an alloy steel with a carbon content of 0.40% to 0.45% and suitable alloying elements, such as a 1045 steel-type of pin material which is heat treatable and common in the undercarriage industry, or, alternatively, a 4140 steel-type of pin material capable of being heat treated to a higher hardness level.

The bushing 34 may be made of the base material used for bushings on conventional SALT chains. In an example, the material for the bushing 34 may be an alloy steel with a 0.44% carbon content.

The components of the cartridge 24 and the links 26-1a, 26-1b, 26-2a, 26-2b may be hardened in a conventional manner in the undercarriage industry. The degree of hardening would depend on the machine platform and specific applications. The pin 32 and links 26-1a, 26-1b, 26-2a, 26-2b may be hardened using conventional hardening processes to conventional hardness levels for such components (e.g., induction hardening and/or other forms of heat treatment depending on the economics and requirements of the specific component). The inner and outer bushing 34 and collars 44, 46, 48, 50 may be through-hardened, with a hardness level of, for example, 48 to 52 HRc (i.e., Hardness Rockwell C), with attention to a softer core. It is contemplated that the heat-treating operations associated with the metal components of the cartridge 24 and the links 26-1a, 26-1b, 26-2a, 26-2b may be tweaked to attain desired results, i.e., optimum strength with minimal brittleness.

Thus, it is seen that the apparatus and methods of the embodiments disclosed herein readily achieve the ends and advantages mentioned as well as those inherent therein. While certain preferred embodiments have been illustrated and described for purposes of the present disclosure, numerous changes in the arrangement and construction of parts and steps may be made by those skilled in the art, which changes are encompassed within the scope and spirit of the present invention as defined by the appended claims.

What is claimed is:

1. An endless track chain for use with a track-type vehicle, the endless track chain comprising:
a first link set and a second link set, the first link set including a first link and a second link, the second link set including a third link and a fourth link;
the first, second, third and fourth links including first, second, third and fourth bores therethrough; and
a cartridge received through the first, second, third and fourth bores and connecting the first link set and the second link set to permit relative rotation between the first link set and the second link set, the cartridge including:
a pin;
a bushing journaled on an axially central portion of the pin for relative rotation between the bushing and the pin;
first and second collars rotatably disposed on the pin on axially opposite sides of the bushing, the first and second collars being received in the first and second bores and having axially form-fitting connections to the first and second links; and
third and fourth collars disposed on the pin axially outboard of the first and second collars, respectively, the third and fourth collars being rotationally fixed within the third and fourth bores and rotationally fixed to the pin, so that the pin and the third and fourth collars are fixed relative to the third and fourth links.

2. The endless track chain of claim 1, wherein the axial form fitting connection between the first collar and the first bore comprises:
a radially outward facing groove defined in an outer surface of the first collar;
a radially inward facing groove defined in an inner surface of the first bore; and
a resilient locking ring partially received in each of the grooves to axially lock the first collar to the first link.

3. The endless track chain of claim 2, wherein:
the resilient locking ring has a rectangular or a square cross-section.

4. The endless track chain of claim 2, further comprising:
a radially outward facing groove defined in an outer surface of the second collar;
a radially inward facing groove defined in an inner surface of the second bore; and
a further resilient locking ring partially received in each of the grooves of the second collar and the second bore to axially lock the second collar to the second link

5. The endless track chain of claim 1, wherein:
the outer surface of the first collar is press-fit within the first bore.

6. The endless track chain of claim 1, wherein:
the outer surface of the first collar is not knurled.

7. The endless track chain of claim 1, wherein:
the third and fourth collars are press fit within the third and fourth bores and are press fit to the pin.

8. The endless track chain of claim 1, wherein:
the first and second collars include first and second seal rings, respectively, engaging opposite axial ends of the bushing; and
the third and fourth collars include third and fourth seal rings, respectively, engaging axially outer ends of the first and second collars, respectively.

9. The endless track chain of claim 1, wherein:
the third collar has a radially outer surface with an outside diameter less than an inside diameter of the first bore of the first link so that the third collar can pass axially through the first bore without being press fit through the first bore.

10. A method of assembling one end portion of a rotating pin cartridge assembly with an axially inner chain link, the cartridge assembly including a pin, an axially inner collar rotatably received on the pin, and an axially outer collar rotationally fixed to the pin, the method comprising:
radially compressing a resilient locking ring within a radially outwardly facing groove of the axially inner collar;
passing the axially outer collar through a bore of the axially inner chain link;
axially moving the axially inner collar into the bore of the axially inner chain link while holding the resilient locking ring radially compressed within the groove until the groove of the axially inner collar aligns with a radially inward facing groove of the bore of the axially inner chain link; and
expanding the resilient locking ring into the radially inward facing groove of the bore of the axially inner chain link to axially lock the axially inner collar to the axially inner chain link.

11. The method of claim 10, wherein:
the passing includes passing the axially outer collar through the bore of the axially inner chain link without any press fitting of the axially outer collar through the bore of the axially inner chain link.

12. The method of claim 10, further comprising:
radially compressing a second resilient locking ring within a radially outwardly facing groove of a second axially inner collar;
passing a second axially outer collar through a bore of a second axially inner chain link;
axially moving the second axially inner collar into the bore of the second axially inner chain link while holding the second resilient locking ring radially compressed within the groove until the groove of the second axially inner collar aligns with a radially inward facing groove of the bore of the second axially inner chain link; and
expanding the second resilient locking ring into the radially inward facing groove of the bore of the second axially inner chain link to axially lock the second axially inner collar to the second axially inner chain link.

13. The method of claim 12, further comprising:
press fitting first and second axially outer chain links to the first and second axially outer collars, respectively.

14. The method of claim 10, further comprising:
press fitting an axially outer chain link to the axially outer collar.

15. The method of claim 10, wherein:
axially moving the axially inner collar into the bore of the axially inner chain link includes press fitting the axially inner collar into the bore of the axially inner chain link.
